(19) United States
(12) Patent Application Publication
(10) Pub. No.: US 2026/0128308 A1
(43) Pub. Date: May 7, 2026

(54) SPACE-RATED BATTERY PACK

(71) Applicant: K2 Space Corporation, Torrance, CA (US)

(72) Inventor: Neeldev KUNJUR, Torrance, CA (US)

(73) Assignee: K2 Space Corporation, Tprrance, CA (US)

(21) Appl. No.: 19/435,381

(22) Filed: Dec. 29, 2025

Related U.S. Application Data
(63) Continuation of application No. PCT/US2024/036175, filed on Jun. 28, 2024.
(60) Provisional application No. 63/524,001, filed on Jun. 29, 2023.

(51) Int. Cl. H01M 4/58; B64G 1/42; B64G 1/44; B64G 1/54; H01M 10/42; H01M 50/224; H01M 50/24; H01M 50/249

(52) U.S. Cl. CPC H01M 4/5825; B64G 1/425; B64G 1/443; B64G 1/546; H01M 10/425; H01M 50/224; H01M 50/24; H01M 50/249; H01M 2010/4271; H01M 2220/20

(57) ABSTRACT

A battery pack for use in a spacecraft is provided. The battery pack includes one or more cells and an enclosure operable to receive the one or more cells therein. The one or more cells have a cathode material that includes lithium, iron, and phosphate. The enclosure is constructed at least partially of aluminum and is operable to provide radiation shielding.

### CROSS-REFERENCE TO RELATED APPLICATION

This application is a continuation of International Patent Application PCT/US24/036175 filed Jun. 28, 2024, which claims the benefit of U.S. Provisional Patent Application No. 63/524,001, filed in the U.S. Patent and Trademark Office on Jun. 29, 2023, each of which is incorporated herein by reference in its entirety for all purposes.

### FIELD

The present disclosure relates generally to a space-rated battery pack. In at least one example, the present disclosure relates to a space-rated battery pack containing Lithium Iron Phosphate (LFP) battery cells and a battery management system (BMS) enclosed within an aluminum radiation shield.

### BACKGROUND

Conventional battery packs for use in space are optimized for high energy density. For example, some conventional battery packs utilize cell chemistries such as Nickel Manganese Cobalt (NMC), which suffers from issues related to thermal runaway, narrow charge/discharge temperature range, and low life cycles.

### BRIEF DESCRIPTION OF THE DRAWINGS

Implementations of the present technology will now be described, by way of example only, with reference to the attached figures, wherein:

FIG. 1 illustrates an environment for the battery pack, according to the present disclosure;

FIG. 2 illustrates the battery pack mechanical design, including battery cells for a battery management system (BMS) enclosed within a radiation shield;

FIG. 3 is a diagram illustrating a power architecture;

FIG. 4 illustrates Nickel Manganese Cobalt (NMC) cell chemistry versus conventional Lithium Iron Phosphate (LFP) cell chemistry;

FIG. 5 illustrates NMC cell performance versus LFP cell performance; and

FIG. 6 is a graph that illustrates the effectiveness of the aluminum shielding of the battery pack as a function of aluminum thickness.

### SUMMARY

Aspects of the present disclosure include a battery pack for use in a spacecraft. The battery pack includes one or more cells and an enclosure. The one or more cells have a cathode material that includes lithium, iron, and phosphate. The enclosure, which can receive the one or more cells, is at least partially made of aluminum and can provide radiation shielding.

In various possible examples, the cathode material includes LiFePO4.

In various possible examples, the battery pack includes a battery management system coupled with the one or more cells. The battery management system can monitor performance of the one or more cells. In some examples, the performance of the one or more cells includes temperature, managing operation performance within safe operating area, voltage, current, and/or state of balance between the one or more cells. In some examples, the battery management system is received in the enclosure.

In various possible examples, the one or more cells are rechargeable.

Aspects of the present disclosure include a spacecraft that includes one or more solar arrays, a battery pack, and an enclosure. The battery pack, which is coupled to the one or more solar arrays, includes one or more cells that have cathode material that includes lithium, iron, and phosphate. The enclosure, which can receive the one or more cells, is at least partially made of aluminum and can provide radiation shielding. The one or more cells can store energy and can be charged by the one or more solar arrays.

In various possible examples, the cathode material includes LiFePO4.

In various possible examples, the spacecraft includes a battery management system coupled with the one or more cells. The battery management system can monitor performance of the one or more cells. In some examples, the performance of the one or more cells includes temperature, managing operation performance within safe operating area, voltage, current, and/or state of balance between the one or more cells. In some examples, the battery management system is received in the enclosure.

In various possible examples, the one or more cells are rechargeable.

In various possible examples, the spacecraft includes one or more spacecraft components coupled with the battery pack such that the battery pack can supply power to the one or more spacecraft components.

In various possible examples, the enclosure can mount the battery pack to a structure of the spacecraft

In various possible examples, the spacecraft includes a satellite.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Conventional space-rated battery pack design has been driven by mass and volume constraints, utilizing mass optimized materials and technology throughout the design. These conventional designs, while mass optimal, result in significant tradeoffs. For example, these designs are optimized for high energy density, utilizing cell chemistries such as Nickel Manganese Cobalt (NMC) which suffer from issues related to thermal runaway, narrow charge/discharge temperature range, and low cycle life (<2000 cycles). The need to mitigate thermal runaway of NMC cell chemistries results in significant battery pack complexity, often requiring fusible cell interconnects, active disconnect devices, and significant thermal management which increase battery pack costs. Additionally, these NMC chemistries utilize rare earth minerals which are significantly supply constrained, increasing cost. Moreover, these designs incorporate radiation hardened electronics components, which require less shielding but have significantly higher cost and reduced performance compared to readily available components.

Conventional lithium-ion (also referred to as Li-ion) based battery packs require complex/expensive design features to mitigate thermal runaway risk. These features can include fusible interconnects which can reduce battery pack reliability, complex thermal management systems, and venting designs. Each of these features, in turn, require complex and costly ground testing to validate. Additionally, conventional Li-ion based battery packs have relatively low cycle life, requiring reduced mission lifetimes or increased overall battery mass to reduce depth of discharge per orbit. Conventional Li-ion based battery packs have a narrower thermal operating range, which places constraints on the spacecraft operations and thermal design. Additionally, conventional Li-ion based battery packs rely on cell chemistries that require rare earth metals in their cathodes. The costs of cell material procurement is high due to the scarcity of these resources. Typical space battery packs are heavily mass optimized, meaning the enclosures are either made of composite materials which do not provide significant shielding, or use very thin aluminum walls with minimal shielding.

Provided herein is a space-rated battery pack for use in high-power satellites. The battery pack includes battery cells containing Lithium Iron Phosphate (LFP), a battery management system (BMS), and an enclosure that provides a radiation shield around the LFP battery cells and the BMS. The battery pack can be charged via solar arrays mounted to the spacecraft (e.g., satellite) such that the battery cells can store energy onboard the spacecraft. The stored energy can be used while the spacecraft is in eclipse.

Each of the battery cells utilizes LFP chemistry, which provides excellent thermal performance, cycle life, mineral availability, and safety with a relatively high thermal runaway temperature compared to conventional space-rated battery packs. As a result, the LFP chemistry of the battery cells enables lower cost, enhanced safety/reliability, and longer lasting performance compared to conventional space-rated battery packs. The space-rated BMS, which is incorporated into the battery pack, is optimized for operation with the relatively flat voltage vs. state-of-charge (SOC) curve inherent in LFP cells. The enclosure includes an aluminum radiation shield, which allows the BMS to incorporate readily-available components rather than conventional high cost, low performance radiation-hardened components.

LFP battery cells have been limited in their use in space primarily given the reduction in gravimetric energy density (energy per unit mass) compared to other, higher performance cell chemistries. Spacecraft have traditionally been extremely mass constrained, leading designers to maximize gravimetric energy density in their selection of battery cells. Such optimization has traditionally pushed manufacturers away from using LFP cells in space battery packs, leading to significant complexity and cost.

The battery pack disclosed herein can provide significant benefits over conventional equipment. For example, the battery pack disclosed herein utilizes LFP, which includes readily available materials, less expensive to manufacture, has longer cycle life, has better thermal performance, and utilizes a shield to protect the battery cells so that each component does not need to be radiation hardened. Thus, the present disclosure is a low-cost, high cycle life battery pack.

The presently disclosed space-rated battery pack, through the use of LFP battery cells and the BMS design, addresses many of the shortcomings of conventional space-rated battery packs. For example, the space-rated battery pack of the present disclosure provides passive thermal runaway resistance without the need for dedicated thermal runaway prevention features. Additionally, the presently disclosed battery pack has a significantly longer cycle life (>6000 cycles) than conventional space-rated battery packs. The battery pack disclosed herein has significantly reduced cell procurement cost compared to cell chemistries used conventionally in space-rated battery packs due to the elimination of rare earth metals from the cell cathode. The presently disclosed battery pack provides SOC estimation optimized for operation of LFP battery cells in the space environment. Finally, the battery pack disclosed herein utilizes heavy aluminum shielding to provide sufficient radiation effects mitigation to enable the use of low-cost, high-performance, readily available electronic components rather than radiation hardened parts.

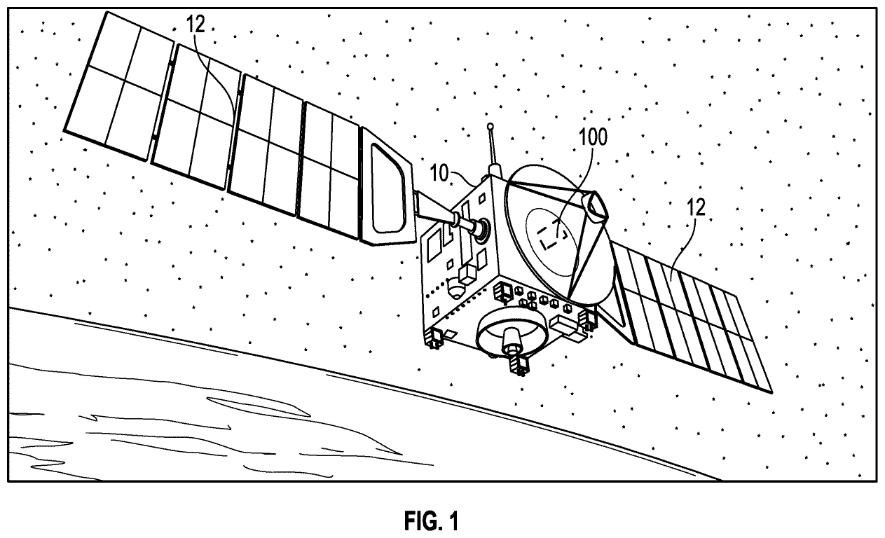

FIG. 1 illustrates a battery pack 100 operable to be used in a space environment. The battery pack 100 can be employed in (or disposed within) a spacecraft such as, for example, a satellite 10. Although this disclosure refers to a battery pack 100 configured for use in a satellite 10, the battery pack 100 can be configured for use in another spacecraft (e.g., crewed spacecraft, spaceplane, uncrewed spacecraft, space telescope, cargo spacecraft). In some examples, the battery pack 100 can include a large, space-rated battery pack 100 for use in a high-powered satellite 10. In some examples, the spacecraft (e.g., satellite 10) includes one or more solar arrays 12 (e.g., solar panels), which can be configured to charge the battery pack 100.

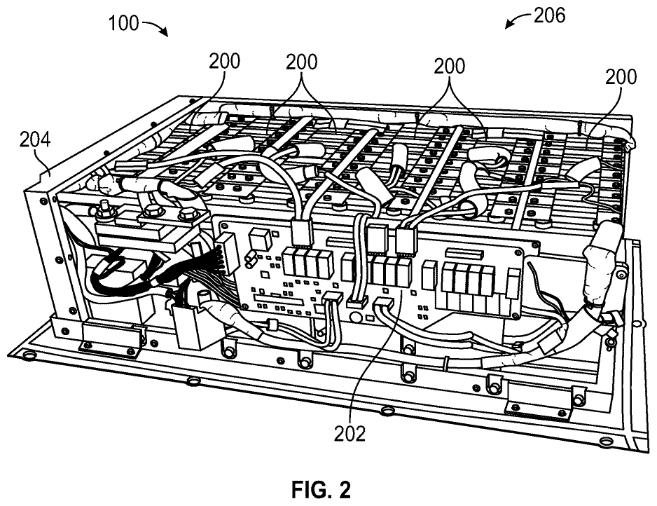

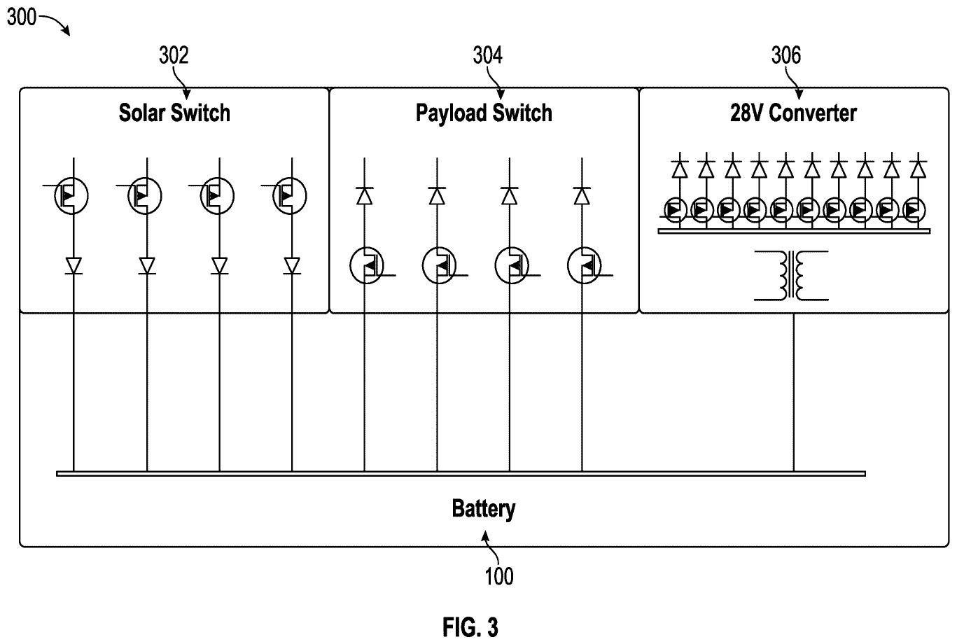

In some examples, the battery pack 100 (for example, as illustrated in FIG. 2) can store and/or supply energy (also referred to as power) to one or more components of the spacecraft. For example, the battery pack 100 can be communicatively coupled to the spacecraft (e.g., payload, spacecraft loads), such as with the payload switch card 304 and/or converter card 306 as illustrated for example in the power architecture 300 in FIG. 3 and discussed in further detail below, and can supply energy to the spacecraft load(s) (e.g., when the spacecraft is in eclipse). In some examples, the battery pack 100 can receive and/or store energy. For example, the battery pack 100 can be communicatively coupled to the solar arrays 12, such as with solar array switch card 302 as illustrated for example in the power architecture 300 in FIG. 3, and the battery pack 100 can receive energy from the one or more solar arrays 12. In some examples, the battery pack 100 can be configured to be recharged, such that the battery pack 100 is rechargeable. For example, the battery pack 100 can supply energy to the spacecraft and/or receive energy from the solar arrays 12. After receiving energy, the battery pack 100 (e.g., the battery cells 200) can store energy for subsequent use. The battery pack 100 can then deliver the stored energy to one or more components of the satellite 10.

FIG. 2 illustrates a battery pack 100. The battery pack 100 can be employed in a satellite 10 (for example as illustrated in FIG. 1) or another suitable spacecraft. The battery pack 100 can be operable to store energy onboard the spacecraft (e.g., satellite 10) for example for use while the spacecraft is in eclipse. The battery pack 100 includes one or more battery cells 200, a battery management system (BMS) 202, and an enclosure 204. In some examples, the battery pack 100 (e.g., the enclosure 204) is generally shaped as a rectangular box with the one or more battery cells 200 contained therein. While FIG. 2 illustrates the enclosure 204 as being open, in some examples, the enclosure 204 can be closed to fully encapsulate the battery cells 200.

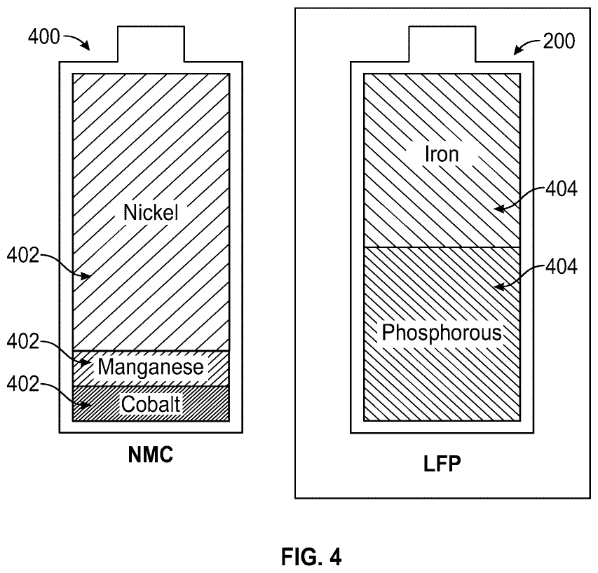

The one or more battery cells 200 (also referred to as cells) can be received within (or disposed within) the enclosure 204 of the battery pack 100. In some examples, the battery cell(s) 200 can be at least partially enclosed in the enclosure 204. In some examples, the battery cell(s) 200 can be fully enclosed in the enclosure 204. Each of the battery cells 200 can be operable to receive energy (e.g., from one or more solar arrays 12), store energy, and/or supply energy (e.g., to spacecraft components and/or loads). As illustrated for example in FIG. 4, each of the battery cells 200 can utilize a Lithium Iron Phosphate (LFP) chemistry. In some examples, the battery cells 200 can be generally prismatic in shape, as illustrated for example in FIG. 2. In some examples, the battery cells 200 can be generally pouch shaped or generally cylindrical in shape. In some examples, multiple battery cells 200 can be arranged in a battery module 206. The battery cells 200 can be stacked in the main battery compartment (e.g., within the enclosure 204) with interconnects (e.g., welded, bolted) connecting the battery cells 200 to the BMS 202. In some examples, the one or more battery cells 200 can be rechargeable (such as by the solar arrays 12 as illustrated in FIG. 1).

The BMS 202 can be received within (or disposed within) the enclosure 204 of the battery pack 100. In some examples, the BMS 202 includes a printed circuit board assembly (PCBA), as illustrated for example in FIG. 2. The BMS 202 is communicatively coupled to the one or more battery cells 200 and configured to monitor and/or optimize the performance of the battery cells 200. Non-limiting examples of performance of the battery cells 200, which the BMS 200 can monitor includes temperature, managing operation performance within safe operating area, voltage, current, and/or state of balance between the battery cells 200. In at least one example, the BMS 202 can be configured to optimize the operation of the relatively flat voltage vs. state-of-charge (SOC) curve inherent in LFP battery cells 200. In some examples, the BMS 202 can be positioned at the front of the battery pack 100 (e.g., the front of the enclosure 204) and the battery cells 200 are located behind the BMS 202 (e.g., the rear of the enclosure 204), as illustrated for example in FIG. 2. In some examples, the BMS 202 can be positioned above the battery cells 200, under the battery cells 200, or to the side of the battery cells 200 without deviating from the scope of the disclosure.

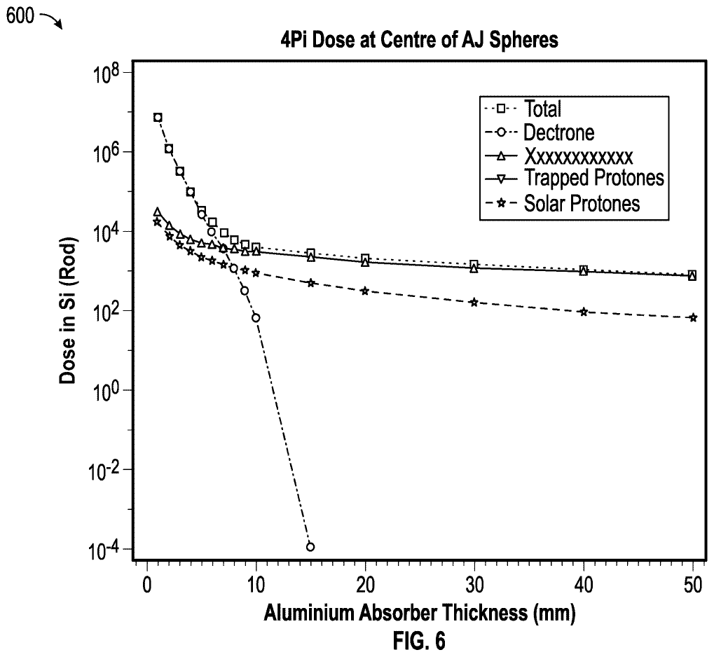

The enclosure 204 (also referred to as the shielding or the shell) of the battery pack 100 is operable to receive the one or more battery cells 200 and/or the BMS 202. In at least one example, the enclosure 204 encloses both the battery cells 200 and the BMS 202. For example, the enclosure 204 can include a casing in which the battery cells 200, the BMS 202, and/or other battery components are contained. The enclosure 204 can be configured to be mounted to a structure of a spacecraft such as a satellite 10 (as illustrated for example in FIG. 1). In at least one example, the enclosure 204 is at least partially made of aluminum (e.g., machined aluminum) and provides mechanical and thermal interfaces for both the internal battery components (e.g., battery cells 200) and external mounting features to mount the battery pack 100 to the spacecraft (e.g., satellite 10) structure. In some examples, the enclosure 204 can be greater than 50% aluminum. In some examples, the enclosure 204 can be greater than 75% aluminum. In some examlpes, the enclosure 204 can be greater than 90% aluminum. In some examples, the enclosure 204 is entirely made of aluminum. The aluminum enclosure 204 can provide radiation shielding to internal components of the battery pack 100, for example the BMS 202 and/or the battery cells 200, with the degree of shielding maximized by increasing the thickness of the aluminum enclosure 204 used around the BMS 202. For example, FIG. 6 below is a graph 600 that illustrates the effectiveness of the aluminum enclosure 204 as a function of aluminum thickness.

FIG. 3 illustrates a power architecture 300 for the battery pack 100. The battery pack 100 (as illustrated for example in FIG. 2) can be incorporated into the power architecture 300. The power architecture 300 can include a battery pack 100, a solar array switch card 302 (also referred to as a solar switch), a payload switch card 304 (also referred to as a payload switch), and/or a converter card 306 (also referred to as 28V converter card). The solar array switch card 302 can be operable to control the flow of electricity generated by the solar panels 12 (e.g., to one or more components of the spacecraft). The solar array switch card 302 can be operable to provide protection such as overcurrent protection and short-circuit protection. The payload switch card 304 can be operable to switch between different payloads carried by the satellite 10 based on mission requirements. The converter card 306 can be operable to convert signals, data, or power between different forms or formats, facilitating compatibility and functionality within various systems and applications.

The battery pack 100 can store energy onboard the spacecraft (e.g., satellite 10). In some examples, the battery pack 100 is configured to received energy (e.g., be charged and/or recharged) via one or more solar arrays 12 (for example as illustrated for example in FIG. 1). For example, the solar arrays 12 can be communicatively coupled or connected to the battery pack 100 (e.g., connected to the battery cells 200) through a solar array switch card 302. The solar array switch card 302 applies and/or removes solar array power (from the solar arrays 12) to charge the battery pack 100 (e.g., charge the battery cells 200). In some examples, the solar array switch card 302 can be switched between an open position and a closed position. In some examples, when the solar array switch card 302 transitions to a closed position (a closed circuit), the solar arrays 12 can charge the battery pack 100. In some examples, when the solar array switch card 302 transitions to an open position (an open circuit), the solar arrays 12 cannot charge the battery pack 100.

In at least one example, the battery pack 100 can supply stored energy to the spacecraft (e.g., supply power to the payload, supply power to the spacecraft loads), such as when the spacecraft is in eclipse. In some examples, the spacecraft does not include any shade systems onboard.

In some examples, the battery pack 100 can supply power to the payload. For example, the battery pack 100 can be communicatively coupled or connected to a payload switch card 304 for supplying payload power. In some examples, the payload array switch card 304 can be switched between an open position and a closed position. In some examples, when the payload array switch card 304 transitions to a closed position (a closed circuit), the payload can receive power from the battery pack 100. In some examples, when the payload array switch card 304 transitions to an open position (an open circuit), the payload cannot receive power from the battery pack 100.

In some examples, the battery pack 100 can supply power to the spacecraft components and/or loads (e.g., various spacecraft subsystems). For example, the battery pack 100 can be communicatively coupled or connected to a converter card 306 (e.g., 28V converter card) for supplying spacecraft load(s). In some examples, the converter card 306 can be switched between an open position and a closed position. In some examples, when the converter card 306 transitions to a closed position (a closed circuit), the spacecraft load(s) can receive power from the battery pack 100. In some examples, when the converter card 306 transitions to an open position (an open circuit), the spacecraft loads cannot receive power from the battery pack 100. In some examples, the converter card 306 is configured to convert energy (also referred to as power) to 28 VDC.

FIG. 4 is a diagram illustrating the cell chemistry of a conventional Nickel Manganese Cobalt (NMC) battery cell 400 versus the cell chemistry of a Lithium Iron Phosphate (LFP) battery cell 200. The LFP battery cell 200 (as illustrated for example in FIG. 4) can have the same or similar features as the battery cell 200 as previously discussed.

The LFP cell chemistry (e.g., the LFP battery cell 200) utilizes Lithium Iron Phosphate as the cathode material 404 (also referred to as the cathode composition). In other words, the cathode material 404 of the LFP battery cell 200 is Lithium Iron Phosphate. In some examples, the cathode material 404 of the LFP battery cell 200 is LiFePO4. On the other hand, the conventional NMC cell chemistry (e.g., the NMC battery cell 400) utilizes Lithium Nickel Manganese Cobalt Oxide as the cathode material 402 (also referred to as cathode composition). In some examples, the cathode material 402 in the conventional NMC battery cell 400 is LiNixMnyCozO2. It should be noted here that the comparison diagram illustrated in FIG. 4 does not show lithium, since lithium is a common element in both cathode compositions 402, 404.

In some examples, the LFP battery cell 200 provides passive thermal runaway resistance. For example, LFP battery cells 200 (e.g., cathode material 404) contain a different chemical composition compared to NMC battery cells 400 (e.g., cathode material 402). The chemical composition of the LFP battery cells 200 (e.g., cathode material 404) leads to lower heating rates and lower maximum temperatures relative to NMC battery cells 400. These two characteristics, in turn, lead to a significantly lower risk of thermal runaway propagation to nearby battery cells 200, meaning single cell failures are contained to a single cell within the battery pack 100.

On the other hand, chemistries such as conventional NMC (as included in NMC battery cells 400) exhibit very high heating rates and relatively high maximum temperatures under thermal runaway conditions meaning a single cell failure is highly likely to propagate to nearby cells within the pack, triggering full pack thermal runaway. Battery packs based around conventional NMC cell chemistries require significantly complex safety features to mitigate this inherent behavior, including fusible cell interconnects, thermal isolation features, and venting features, all of which add cost and complexity to the battery pack design.

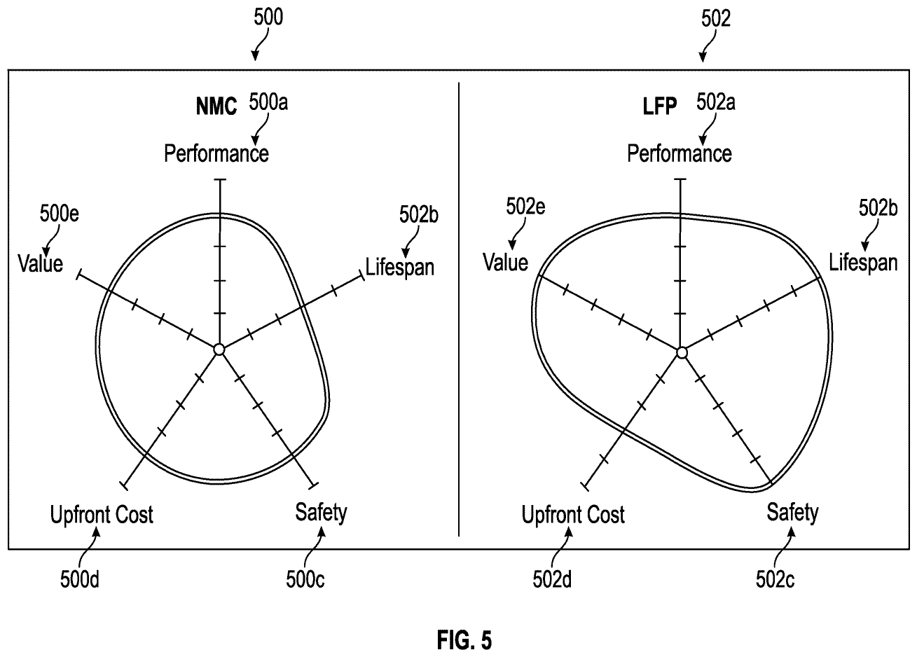

FIG. 5 includes graphical representations that illustrate the attributes of a Nickel Manganese Cobalt (NMC) cell 500 (e.g., 500a, 500b, 500c, 500d, 500e) versus the attributes of a Lithium Iron Phosphate (LFP) cell 502 (e.g., 502a, 502b, 502c, 502d, 502e). In some examples, the attributes of the NMC cell performance 500 represent the attributes of a conventional NMC battery cell. In some examples, the attributes of the LFP cell 502 (as illustrated for example in FIG. 5) represents the attributes of an LFP battery cell 200 (as illustrated for example in FIG. 4). In some examples, the performance (e.g., energy, density, etc.) of the LFP battery cell 200 varies based on the cell design or specifications.

The graphical representations illustrate a comparison of the performance 500a, lifespan 500b, safety 500c, upfront cost 500d, and value 500e of the NMC cell 500 versus the corresponding performance 502a, lifespan 502b, safety 502c, upfront cost 502d, and value 502e of the LFP cell 502. In some aspects, the attributes of the LFP cell 502 are improved over the attributes of the NMC cell 500. In some aspects, the LFP cell performance 502a is equal to or greater than the NMC cell performance 500a. In some aspects, the LFP cell lifespan 502b is greater than the NMC cell lifespan 500b. In some aspects, the LFP cell safety 502c is greater than the NMC cell safety 500c. In some aspects, the LFP cell upfront cost 502d is less than the NMC cell upfront cost 500d. In some aspects, the LFP cell value 502e is greater than the NMC cell value 500e.

FIG. 6 is a graph 600 that illustrates the effectiveness of the aluminum shielding (such as that of the enclosure 204 of the battery pack 100 as illustrated for example in FIG. 2) as a function of aluminum thickness. In at least one example, the shielding is purely aluminum (e.g., aluminum material). The aluminum shielding mitigates the effects of accumulated radiation dose by absorbing incident particles prior to these particles interacting with the active material contained within the electronics. FIG. 6 illustrates the amount of radiation shielding as a function of the aluminum thickness and radiation environment, with an example curve demonstrating the shielding effectiveness as a function of aluminum thickness for various particles in geostationary orbit (also referred to as a geosynchronous equatorial orbit or GEO).

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure to the full extent indicated by the broad general meaning of the terms used in the attached claims. It will therefore be appreciated that the embodiments described above may be modified within the scope of the appended claims.

What is claimed is:

1. A battery pack for use in a spacecraft, the battery pack comprising:
one or more cells having cathode material including lithium, iron, and phosphate;
an enclosure operable to receive the one or more cells, the enclosure being at least partially made of aluminum and operable to provide radiation shielding.

2. The battery pack of claim 1, wherein the cathode material includes LiFePO4.

3. The battery pack of claim 1, further comprising a battery management system coupled with the one or more cells, the battery management system operable to monitor performance of the one or more cells.

4. The battery pack of claim 3, wherein the performance of the one or more cells includes temperature, managing operation performance within safe operating area, voltage, current, and/or state of balance between the one or more cells.

5. The battery pack of claim 3, wherein the battery management system is received in the enclosure.

6. The battery pack of claim 1, wherein the one or more cells are rechargeable.

7. The battery pack of claim 1, wherein the enclosure includes greater than 50% aluminum.

8. The battery pack of claim 1, wherein the enclosure is entirely made of aluminum.

9. The battery pack of claim 1, wherein the one or more cells provides passive thermal runaway resistance.

10. A spacecraft comprising:
one or more solar arrays;
a battery pack coupled with the one or more solar arrays, the battery pack including: one or more cells having cathode material including lithium, iron, and phosphate;
an enclosure operable to receive the one or more cells, the enclosure being at least partially made of aluminum and operable to provide radiation shielding,
wherein the one or more cells is operable to store energy and be charged via the one or more solar arrays.

11. The spacecraft of claim 10, wherein the cathode material includes LiFePO4.

12. The spacecraft of claim 10, further comprising a battery management system coupled with the one or more cells, the battery management system operable to monitor performance of the one or more cells.

13. The spacecraft of claim 12, wherein the performance of the one or more cells includes temperature, managing operation performance within safe operating area, voltage, current, and/or state of balance between the one or more cells.

14. The spacecraft of claim 12, wherein the battery management system is received in the enclosure.

15. The spacecraft of claim 10, wherein the one or more cells are rechargeable.

16. The spacecraft of claim 10, further comprising one or more spacecraft components coupled with the battery pack such that the battery pack is operable to supply power to the one or more spacecraft components.

17. The spacecraft of claim 10, wherein the enclosure is operable to mount the battery pack to a structure of the spacecraft.

18. The spacecraft of claim 10, wherein the enclosure is greater than 50% aluminum.

19. The spacecraft of claim 10, wherein the enclosure is entirely made of aluminum.

20. The spacecraft of claim 10, wherein the spacecraft includes a satellite.
